(19) United States
(12) Patent Application Publication
(10) Pub. No.: US 2005/0108370 A1
(43) Pub. Date: May 19, 2005

(54) Framework for managing an optical communication network

(76) Inventors: Alain Sarraf, Herrenberg (DE); Albrecht Schroth, Boeblingen (DE)

Correspondence Address: PERMAN & GREEN, 425 POST ROAD, FAIRFIELD, CT, 06824, US

(21) Appl. No.: 10/495,260

(22) PCT Filed: May 24, 2002
(86) PCT No.: PCT/EP02/05698

(30) Foreign Application Priority Data
Nov. 20, 2001 (EP) 01127640.9

(51) Int. Cl. G06F 15/173

(52) U.S. Cl. 709/223

(57) ABSTRACT

A framework for managing a communication network is described. Network elements and/or test devices as well as a physical layer management system is provided. The network elements and/or the test devices are coupled with the physical layer management system via a generic and standardized first interface. The physical layer management system and a logical management layer are coupled via a generic and standardized second interface.

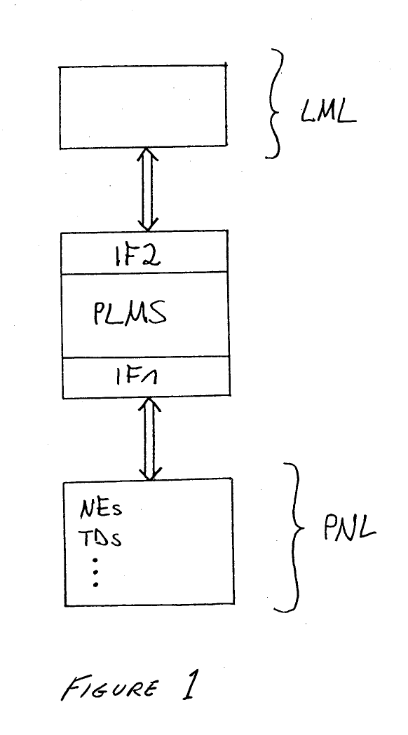

### BACKGROUND OF THE INVENTION

The invention relates to the management of a communication network.

It is known to manage the transmission equipment of a network, i.e. the network elements of the communication network with a network management system which views these network elements at the logical layer of the network. This logical management layer is adapted to those kind of network elements which are present in the communication network. It may be adapted to the network elements of a specific company or may support the management of the network elements from multiple vendors. The logical management layer does not concern itself with the physical attributes of the network. For example, it may know that two network elements exist in the communication network. It may also be capable of processing information coming from these network elements. It may also know that these two network elements are interconnected somehow since they are able to communicate. However, it will not know exactly how these network elements are interconnected, e.g. using fibers, cables or the like. It will also not know whether or not there are test devices attached to the connection between these network elements. It will also not know where the network elements are geographically located.

It is also known to influence the test devices and other physical components like fibers, cables and other physical network inventory of the communication network with a physical layer management system. For that purpose, the physical layer management system concerns itself with the management of all physical attributes of the communication network such as network inventory, physical connectivity of cables, geographic data, physical transmission signals, optical wavelengths and so on.

### OBJECT AND ADVANTAGES OF THE INVENTION

It is therefore an object of the invention to provide an improved management of a communication network.

This object is solved by the subject matters of the independent claims.

The invention provides a framework for managing a communication network which allows the management of both, the network elements at the logical layer of the network and the test devices and physical components at the physical layer of the communication network. This has the advantage that information pertaining to both the physical and the logical layers of the network are available to the users of the network management system simultaneously.

In the prior art, networks were managed at the logical layer since logical layer information was the only information relevant for the management of the network. As networks evolve, the physical characteristics of the network become more and more important. For example, if used properly, information about the physical characteristics of the network can be used to increase the amount of data which can be transmitted between two points in the communication network. It can also be used to determine whether or not the physical layer of the network is responsible for communication problems.

According to the invention, the network elements and/or the test devices are coupled with the physical layer management system via a generic and standardized first interface.

The interface is generic in that it is defined for a general class of devices and can be adapted to any object in the network. In this way, test devices which adhere to this interface may be managed by the physical layer management system. That is, the physical layer management system can control these test devices to instruct them to perform tests in a specified manner.

The invention has the advantage that any kind of logical management layer can have access to the information and test devices which are managed by the physical layer management system. The network elements and/or the test devices must not be provided anymore by one specific company. As well, the provider of the physical layer management system may also be different. The generic and standardized first interface allows to use the products of different companies being coupled together.

The invention therefore allows to use the network elements and the test devices of the communication network more efficiently.

In an embodiment of the invention, the logical management layer is coupled with the physical layer management system via a generic and standardized second interface. Again, the second interface allows to couple together the products of different companies.

Further embodiments of the invention are provided in the other dependant claims.

### DETAILED DESCRIPTION OF EMBODIMENTS OF THE INVENTION

The only FIGURE shows an embodiment of a network management system according to the invention.

A communication network of e.g. a company, comprises a large number of network elements NEs. These network elements NEs are the active transmission devices which are necessary to build up the communication network, e.g. multiplexers and other transmission equipment. The network elements NEs are connected by passive transmission devices, e.g. fibers, cables, conduits.

Furthermore, a number of test devices TDs are provided for performing tests within the communication network. These tests may be carried out to evaluate the quality of the communication network. As well, the tests may be carried out in cases of a failure within the communication network. As an example, a power monitoring device or a wavelength meter or a optical time domain reflectometer may be coupled as test devices TDs to the communication network.

All network elements NEs and all test devices TDs of the communication network relate to the so-called physical network layer PNL. This physical network layer PNL may furthermore pertain to data concerning other network objects such as cables, fibers, connections between elements, buildings, floors, rooms, racks, bays, and so on, for which the communication network is intended.

A physical layer management system PLMS is provided for managing information about the physical characteristics of the network elements NEs and the test devices TDs within the communication network. Whereas the physical layer management system PLMS is concerned with managing the test devices TDs, e.g. triggering measurements, it is only concerned with the network elements NEs in that it is aware of their presence and configuration. For example, the physical layer management system PLMS does not control the traffic or switching of these network elements NEs. Such responsibilities are left to a logical layer management system.

The physical layer management system PLMS is coupled with the network elements NEs and the test devices TDs via a first interface IF1.

The first interface IF1 allows to couple the physical layer management system PLMS with any kind of network element NE and/or with any kind of test device TD. In particular, the first interface IF1 allows to couple the physical layer management system PLMS with network elements NEs and/or test devices TDs of different companies. This means that the network elements NEs and/or the test devices TDs must not be provided by one and the same company, and that the provider of these network elements NEs and/or test devices TDs must not even be identical to the provider of the physical layer management system PLMS.

The only requirement which the network elements NEs and the test devices TDs should fulfil is to be compliant to a standard defining the hardware and software connection of the first interface IF1. Then, the first interface IF1 is a generic and standardized interface.

The physical layer management system PLMS is coupled with a logical management layer LML via a second interface IF2.

The second interface IF2 allows e.g. a user to influence the physical layer management system PLMS from the logical management layer LML. For that purpose, the second interface IF2 offers the possibility to receive one or more commands in a standardized programming language which are then converted into functions performed by the physical layer management system PLMS. The commands may be input with equipment of the logical management layer LML, e.g. a computer system.

For performing the functions, it is possible that the physical layer management system PLMS comprises a database with all network elements NEs, all test devices TDs, all further network objects of the communication network and all their connections. Insofar, the database may be seen as a copy or an image of the physical network layer PNL. The information concerning the network elements, NEs, the test devices TDs, and so on may be received from the physical network layer PNL, but also from the logical management layer LML.

The functions are then carried out by the physical layer management system PLMS with the help of this database.

As well, it is possible that the functions are carried out by the physical layer management system PLMS directly in the physical network layer PNL. In this case, the physical layer management system PLMS directly influences the network elements NEs and/or test devices TDs.

The second interface IF2 may be connected to any kind of logical layer management system, i.e. a network management system which concerns itself with the logical management layer LML. Insofar, the second interface IF2 is a generic and standardized interface.

As a result, the physical layer management system PLMS with the first and the second interface IF1, If2 allows to couple the network elements NEs and/or the test devices TDs of the physical network layer PNL with the logical management layer LML in a generic and standardized manner. Due to the first and second interfaces IF1, If2, it is possible to have access to physical layer management functionality from within the logical layer management system, e.g. access to test devices TDs and strategies, access to physical inventory attributes, and the like. Conversely, it is possible for the physical layer management system PLMS to have access to information emanating from the logical management system, e.g. currently available network elements NEs and the like.

Furthermore, the physical layer management system PLMS provides functions for the complete management of the physical network layer PNL. In particular, the physical layer management system PLMS provides functions to influence both, the network elements NEs and the test devices TDs. This influence may be performed directly, i.e. on the network elements NEs and/or the test devices TDs of the physical network layer PNL, or indirectly, i.e. in the database comprising the image of the physical network layer PNL.

1. A method of managing a communication network, comprising:
providing at least one of network elements and test devices;
providing a physical layer management system for managing physical attributes of the communication network; and
coupling the at least one of the network elements and the test devices with the physical layer management system via a generic and standardized first interface.

2. The method of claim 1, wherein the first interface is defined for a general class of the at least one of the network elements and test devices.

3. The method of claim 1, further comprising:
providing a logical management layer which views the at least one of the network elements and test devices logically; and
coupling the logical management layer with the physical layer management system via a generic and standardized second interface.

4. The method of claim 3, wherein the second interface is defined for a general class of the at least one of the network elements and test devices.

5. The method of claim 3, wherein the second interface is operable to receive one or more commands in a programming language.

6. The method of claim 3, comprising inputting commands from the logical management layer to the physical layer management system.

7. The method of claim 1, comprising influencing the at least one of the network elements and the test devices with the physical layer management system.

8. The method of claim 1, wherein the communications network is an optical network.

9. A system for managing a communication network comprising:
at least one of network elements and test devices;
a physical layer management system for managing physical attributes of the communication network, wherein the at least one of the network elements and the test devices are coupled with the physical layer management system via a generic and standardized first interface.

10. The system of claim 9, further comprising a logical management layer which views the at least one of the network elements and test devices logically, wherein the logical management layer is coupled with the physical layer management system via a generic and standardized second interface.

11. The system of claim 9, wherein the physical layer management system comprises a database, which is seen as a copy or an image of the physical network layer.
